(19) United States
(12) Patent Application Publication
(10) Pub. No.: US 2026/0177986 A1
(43) Pub. Date: Jun. 25, 2026

(54) STONE FOR A HOROLOGY MOVEMENT

(71) Applicant: ETA SA Manufacture Horlogère Suisse, Grenchen (CH)

(72) Inventors: Joël LOFFEL, Biel/Bienne (CH); Matthieu ERARD, Courroux (CH); Thomas GAUMANN, Schaffhausen (CH)

(73) Assignee: ETA SA Manufacture Horlogère Suisse, Grenchen (CH)

(21) Appl. No.: 19/421,155

(22) Filed: Dec. 16, 2025

(30) Foreign Application Priority Data
Dec. 20, 2024 (EP) 24222276.8

(51) Int. Cl. G04B 31/008

(52) U.S. Cl. CPC G04B 31/0087

(57) ABSTRACT

A stone (1) forming a guide element for the pivot (14) of an axis (12) of a horology mobile (13), the stone (1) including a main part (23) designed to be pressed in a bed (19) of a horology support (16), such as a plate or a bar on a horology movement, as well as a hole (15) for the pivot (14) of said axis (12), the stone (1) including a protruding part (22) forming a protrusion extending from the periphery of the main part (23), the protruding part (22) including said hole (15). Also, a rotational guide device (10) including such a stone (1), and a horology movement including such a guide device (10).

### CROSS REFERENCE TO RELATED APPLICATION

This application claims priority to European Patent Application No. 24222276.8 filed Dec. 20, 2024, the entire contents of which are incorporated herein by reference.

### TECHNICAL FIELD OF THE INVENTION

The invention relates to a stone for a horology movement, for example an industrial stone or a technical ceramic.

The invention also relates to a horology movement comprising such a stone.

### TECHNOLOGICAL BACKGROUND

In the horological state of the art, stones such as ruby, zirconia (ZrO2) or sapphire are used in particular to form endstones or guide elements, known as bearings, in timepieces. These endstones and guide elements are designed to come into contact with pivots to make them rotationally mobile with minimal friction. As such, they form, for example, all or part of a bearing for a rotationally fitted axis. The guide elements generally comprise a through hole for inserting the pivot axis.

In principle, synthetic industrial stones are used in horology movements. In particular, the Verneuil method is commonly used to manufacture monocrystalline stones. There are also polycrystalline stones, which are made by pressing a precursor with a pressing tool to obtain a green body of the future stone. The stones are then sintered and machined into a finished shape with the desired dimensions. In particular, in the case of guide elements made of polycrystalline stone, the pressing tool is provided with a wire, for example, which helps to produce a hole ebauche.

FIG. 1 is a schematic representation of a stone 11 forming a guide element for a pivot on a rotating mobile according to the prior art. The stone 11 is pressed in a bed 2 of a support 4, in this case a bar in a horology movement. In some configurations, the stone 11 is arranged at the edge 8 of the support 4, when the rotating mobile requires such a position.

In this example, the stone 11 is circular and comprises a through hole 5 centred in its centre, the stone 11 being concentric. The bed 2 for the stone 11 is fitted with an opening 6 at the edge 8 of the support 4, and comprises two countersinks 3 to poise the forces exerted on the stone 11. The stone 11 is thus held by three support faces 7, 9, two support faces 7 being positioned between the edge 8 and a different countersink 3, and the third support face 9 is arranged between the two countersinks 3.

However, the surface into which the stone 11 is pressed is limited, particularly due to the width of the opening 6 in the edge 8, which must be compensated by the two countersinks 3. As a result, the three support faces 7, 9 offer an insufficient press-in surface, such that the stone 11 could be driven out of the bed in the event of a shock, as it is not sufficiently held in place.

### SUMMARY OF THE INVENTION

The present invention aims to remedy all or part of the aforementioned drawbacks by providing a stone that can be pressed into a bed with a larger press-in surface.

To this end, the invention relates to a stone forming a guide element for the pivot of an axis of a horology mobile, the stone comprising a main part designed to be pressed into a bed of a horology support, such as a plate or a bar on a horology movement, as well as a hole for the pivot of said axis.

The stone is remarkable in that it comprises a protruding part forming a protrusion extending from the periphery of the main part, the protruding part comprising said hole.

This stone can therefore be pressed into a bed with a larger press-in surface, while keeping the guide hole in the support opening.

In fact, the protruding part comprising the hole is in the same place as that of the stone in the prior art, but the main part of the stone is anchored further inside the support, and is larger. As a result, the press-in surface is larger, so that it is held more securely and there is less risk of the stone being driven out.

According to a particular embodiment of the invention, the main part has a substantially circular shape.

According to a particular embodiment of the invention, the main part comprises a truncated face, preferably positioned opposite the protruding part.

According to a particular embodiment of the invention, the protruding part has a concentric semi-circular shape around the hole.

According to a particular embodiment of the invention, the stone is of the polycrystalline type, comprising, for example, Al2O3Cr polyruby, or preferably ZrO2 zirconia.

According to a particular embodiment of the invention, the main part has a diameter greater than the diameter of the protruding part.

The invention also relates to a rotational guide device for an axis of a horology mobile, the guide device comprising a horology support, such as a plate or a bar, provided with a bed, and such a stone pressed into the bed.

According to a particular embodiment of the invention, the bed comprises a lateral opening at the edge of the support.

According to a particular embodiment of the invention, the stone is arranged in the bed such that at least a portion of the protruding part protrudes from the bed through said lateral opening.

According to a particular embodiment of the invention, the bed is circular outside of the lateral opening.

According to a particular embodiment of the invention, the dimensions of the bed correspond to those of the main part of the stone to enable it to be pressed in.

The invention also relates to a horology movement comprising such a rotational guide device.

### BRIEF DESCRIPTION OF THE DRAWINGS

Other features and advantages will become apparent from the following description, which is provided for illustrative purposes only and is in no way exhaustive, with reference to the appended drawings, in which:

FIG. 1 is a schematic representation of a rotational guide device according to a known embodiment of the prior art;

FIG. 2 is a schematic perspective representation of a view from the underside of part of a horology movement comprising a mobile and a rotational guide device according to the invention;

FIG. 3 is a schematic representation of a cross-sectional view of the axis of a horology mobile fitted in the rotational guide device according to the invention;

FIG. 4 is a schematic representation of a top view of the rotational guide device according to the invention, and

FIG. 5 is a schematic representation of a view from the underside of the rotational guide device according to the invention.

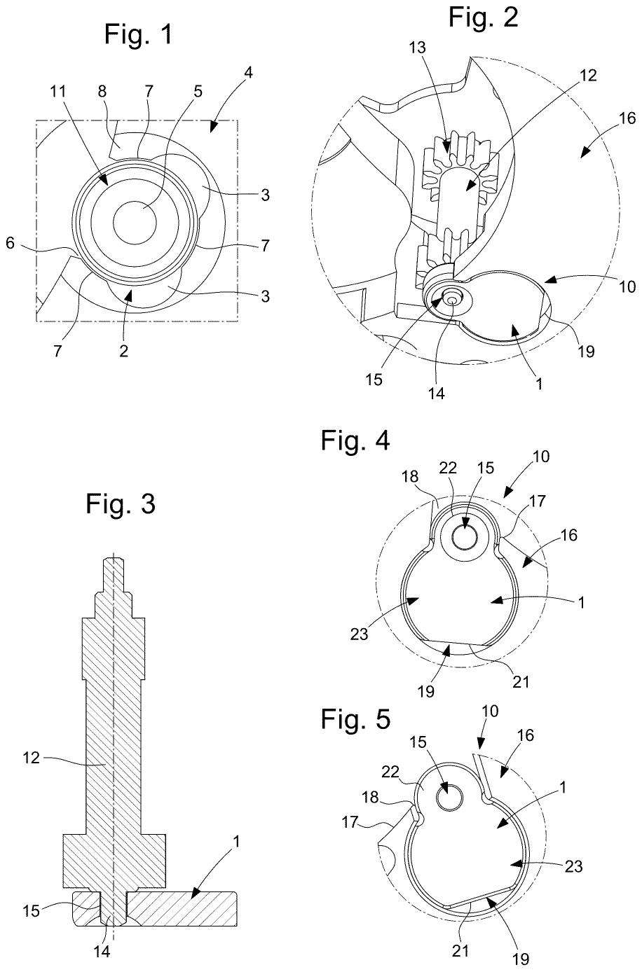

### DETAILED DESCRIPTION OF PREFERRED EMBODIMENTS

As explained above, the invention relates to a stone 1 forming a guide element for the pivot 14 of an axis 12 of a horology mobile 13 and to a rotational guide device 10 comprising such a stone 1, as shown in FIGS. 2 to 4. The horology mobile 13 is, for example, a third wheel mobile.

The stone 1 is of the polycrystalline type and comprises, for example, Al2O3Cr polyruby or ZrO2 zirconia, preferably in its entirety. The stone 1 comprises a main part 23 and a protruding part 22 of said axis 12, as well as a hole 15 for the pivot 14. Preferably, the stone 1 has a substantially constant thickness defined in the same plane.

The main part 23 is designed to be pressed in into the bed 19 of a horology support 16, in this case a bar in a horology movement. The main part 23 has a substantially circular shape. The main part 23 comprises a truncated face 21, preferably positioned opposite the protruding part 22. The truncated face 21 is approximately the same width as the opening 18 in the bed 19 to compensate for the lack of force exerted at this point.

According to the invention, the stone 1 comprises a protruding part 22 forming a protrusion extending from the periphery of the main part 23, the protruding part 22 comprising said hole 15.

The protruding part 22 has a concentric semi-circular shape around the hole 15. The main part 23 has a larger diameter than the protruding part 22.

The main part 23 and the protruding part 22 of the stone 1 form a continuum of material.

The guide device 10 also comprises a horology support 16, in this case a bar, provided with a bed 19 for the stone 1. The dimensions of the bed 19 correspond to those of the main part 23 of the stone 1 to enable it to be pressed in.

The bed 19 comprises a lateral opening 18 at the edge 17 of the support 16. The bed 19 is circular outside the opening 18.

The stone 1 is pressed into the bed 19, so as to position at least a portion of the protruding part 22 projecting from the bed 19 through the said lateral opening 18.

Such a stone 1 is formed, for example, from a precursor, modelled as a green body, which becomes a mineral body comprising, for example, Al2O3Cr polyruby or ZrO2 zirconia ceramic.

For example, the stone 1 is produced using a method comprising a first step in which a precursor is prepared from a mixture of at least one powdered material with a binder. The powder can comprise aluminium oxide to form synthetic sapphire, or a mixture of aluminium oxide and chromium oxide to form synthetic ruby, or zirconium oxide.

In a second pressing step, the precursor is pressed to form a green body of the future stone. A third step in which the green body is sintered enables the mineral body of the future stone to be formed from said at least one material. The method can comprise a fourth machining and/or finishing step.

Of course, the present invention is not limited to the illustrated example but is open to various variants and modifications as will be apparent to the person skilled in the art.

1. A stone forming a guide element for the pivot of an axis of a horology mobile, the stone comprising:
a main part configured to be pressed into a bed of a horology support, and a hole for the pivot of said axis; and
a protruding part forming a protrusion extending from the periphery of the main part, the protruding part comprising said hole.

2. The stone according to claim 1, wherein the main part has a substantially circular shape.

3. The stone according to claim 1, wherein the main part comprises a truncated face, preferably positioned opposite the protruding part relative to the centre of the main part.

4. The stone according to claim 1, wherein the protruding part has a concentric semi-circular shape around the hole.

5. The stone according to claim 1, wherein the stone is of the polycrystalline type, comprising Al2O3Cr polyruby, or ZrO2 zirconia.

6. The stone according to claim 1, wherein the main part has a diameter greater than the diameter of the protruding part.

7. A rotational guide device for an axis of a horology mobile, the guide device comprising:
a horology support, provided with a bed; and
the stone according to claim 1 pressed into the bed.

8. The guide device according to claim 7, wherein the bed comprises a lateral opening at the edge of the support.

9. The guide device according to claim 8, wherein the stone is arranged in the bed such that at least a portion of the protruding part protrudes from the bed through said lateral opening.

10. The guide device according to claim 7, wherein the bed is circular outside of the lateral opening.

11. The guide device according to claim 7, wherein the dimensions of the bed correspond to those of the main part of the stone to enable it to be pressed in.

12. A horology movement, comprising the rotational guide device according to claim 7.
